(19) United States
(12) Patent Application Publication
(10) Pub. No.: US 2011/0058896 A1
(43) Pub. Date: Mar. 10, 2011

(54) CONNECTOR FOR PANELS OR PANEL-LIKE COMPONENTS

(76) Inventor: Pieter Retief Krige, Stellenbosch (ZA)

(21) Appl. No.: 12/863,760

(22) PCT Filed: Mar. 26, 2010
(86) PCT No.: PCT/IB10/00674

§ 371 Date: Jul. 20, 2010

(30) Foreign Application Priority Data
Mar. 26, 2009 (ZA) 2009/02113

(51) Int. Cl. F16B 12/20

(52) U.S. Cl. 403/408.1

(57) ABSTRACT

A connector is provided for connecting a first panel to a second panel. The first panel has one edge fixed relative to a surface of the second panel. The two panels extend transversely to each other. The connector comprises at least one component having a plate-like base with a peripheral edge, an operative outer surface and an inner surface from which one or more attachment lugs extend. The attachment lugs are received in an aperture or recess in the first panel. The attachment lugs are configured to retain the anchor unit in the assembled condition of the connector. In the operative position, two lugs are laterally offset relative to each other and are shaped to cooperate with a fastener passing between them. The fastener urges the two lugs apart to lock the component(s) in position relative to the first panel as the fastener is introduced into its operative position.

This invention relates to a connector that is suitable for use in connecting panels or panel-like components (hereinafter simply termed panels irrespective of their exact nature and function and including frame members and the like), particularly, but not exclusively, panels of articles of furniture and other functional structures. The connection may be either releasable or permanent and the two panels are orientated in intersecting planes, typically, but not necessarily, at right angles to each other, and with an edge of one panel held fast relative to a surface or an edge of the other panel.

The invention relates particularly to connectors of the general type described in my published international patent application number PCT/IB2007/001259 the content whereof is included herein by reference.

### BACKGROUND TO THE INVENTION

The connectors described in my said earlier patent application operate effectively and have proved to be successful. However, their construction is relatively complex and the manner in which the two main components of the connector are drawn towards each other to urge the peripheral region of the plate-like base of each component towards the surface of the panel is dependent, at least to some extent, on the thickness of the panel.

### OBJECT OF THE INVENTION

It is an object of this invention to provide a connector of the general type mentioned above that has improved simplicity and optionally also tolerance towards the thickness of panels in association with which it is used.

### SUMMARY OF THE INVENTION

In accordance with this invention there is provided a connector for connecting a first panel to a second panel with the first panel having one edge thereof fixed relative to a surface of the second panel with the two panels extending transversely to each other, the connector comprising at least one component having a generally plate-like base having a peripheral edge, an operatively outer surface and an inner surface from which one or more attachment lugs extend that are to be received in an aperture or recess in the first panel at or near said edge thereof, the attachment lugs being configured to retain the anchor unit in the assembled condition of the connector by cooperation with a fastener that passes operatively through a hole associated with the second panel and wherein the peripheral edge of the base is shaped so that the base covers the aperture or recess, the connector being characterised in that in the operative position two lugs are laterally offset relative to each other and in that the lugs are shaped for cooperation with the fastener such that the fastener tends to urge the two lugs to lock the component or components in position relative to the first panel as the fastener is introduced into its operative position.

Preferably, the peripheral edge of each base has a flat abutment edge for engaging the surface of the second panel when the fastener is tightened.

In a first variation of the invention the connector comprises two identical components each of which has one or more lugs positioned such that opposite portions of the lugs of the two components in the operative position are spaced apart so that the fastener may enter a space between the two lugs and by so doing urge the peripheral edge of each of the components towards the adjacent surface of the first panel. Preferably, each of the lugs has a groove extending parallel to the axis of the fastener in the installed condition and the grooves are located such that introduction of the fastener between the opposed lugs cooperates with the grooves to draw each base of a component towards a first panel surface. The fastener is preferably screw threaded in order to facilitate its progressive introduction between the lugs and into cooperation with the grooves.

The components may be of injection moulded plastic material that is deformable to a limited extent such that the screw thread of a screw threaded fastener can deform the adjacent surface region of a lug to accommodate a part of the thread of the fastener.

Alternatively, the components may be made of a pressure die-cast metallic material in which instance the thread or a semblance thereof could be moulded into the die-cast metal or it could also deform somewhat as a self tapping or similar screw is introduced into its operative position.

In a second variation of the invention two lugs are formed integral with a single base of a component and the two lugs each have on their remote outer edges outwardly directed catch formations. The two lugs are separated by a slot that enables them to flex inwards or outwards or both to enable the lugs to pass through a restricted zone of the aperture or recess in a first panel with the lugs being urged apart by a fastener introduced between them to cause the catch formations to be urged outwards.

In a first instance of the second variation of the invention a second component may be provided comprising a plate like base having a recess for accommodating the remote ends of the lugs and having cooperating formations for receiving the catch formations in order to lock the two components together in the operative position.

In a second instance of the second variation of the invention a recess in a first panel is suitable for direct engagement by the catch formations to lock the single component in its operative position.

As in the instance of my said earlier patent application, the outer surface of each component may either be shallowly domed or may be totally flat for the purpose of counter-sinking the base so that the outer surface is flush with the surface of the first panel.

The base or bases of the components of the connector may have extensions that terminate in transverse flanges arranged to project inwards at or beyond an edge of the first or second panel so as to provide a finish to a corner where the first and second panel meet at generally right angles to each other. Such flanges may optionally provide co-operant formations for aligning vertically stacked boxes or containers made of panels assembled using connectors of the invention. The transverse flanges may, in the instance of operatively lower edges of the first and second panels, be arranged to pass around the edges of a third panel extending at generally right angles to both the first and second panels and typically forming a bottom to a box or container.

The outer surface of one or other of the components of the anchor unit may further be provided with one or more formations adapted for the attachment of other accessories to the connector such as a hinge, a handle, a lock, or simply a support formation such as for a shelf or as a hanging support.

Still further, two components of a connector may have surfaces of the lugs that are at generally right angles to the plane of the base, and that are in close proximity to each other in the assembled condition of the connector, such surfaces being provided with protrusions and recesses or serrations which interact with each other in the assembled condition to hold the two components together temporarily.

In order that the above and other features of the invention may be more fully understood various different embodiment thereof will now be described with reference to the accompanying drawings.

### BRIEF DESCRIPTION OF THE DRAWINGS

In the drawings:

FIG. 1 is an elevation of an article of furniture of a general nature that could be assembled using connectors of the present invention;

FIG. 2 is a view taken edge-on relative to a second panel and showing a first panel attached thereto using a connector according to the invention;

FIG. 3 is a section taken along line III-III in FIG. 2;

FIG. 4 is an exploded view of the assembly shown in FIGS. 2 and 3;

FIG. 5 is an exploded rearview of the two components;

FIG. 6 is sided view showing the inner surface of the lug of a component;

FIG. 7 is a rearview showing the two components in the operative position relative to a first panel;

FIG. 8 is a perspective view of a modified component of the type illustrated particularly in FIG. 4;

FIG. 9 is an exploded perspective view showing a second embodiment of two components of a connector of the first variation of the invention;

FIG. 10 is a section taken along the line XI to XI in FIG. 9;

FIG. 11 is a perspective view of a component having an added formation for preventing rotation of the connector about the axis of the fastener;

FIG. 12 is an exploded perspective view of a third embodiment of component of the first variation of the invention;

FIG. 13 is a view similar to FIG. 7 illustrating an embodiment of the first variation of the invention that is suitable for use on different thicknesses of panels and showing the components installed in relation to a thinner panel;

FIG. 14 is the same as FIG. 13 showing the components installed in relation to a thicker panel;

FIG. 15 is an exploded rear view of a first embodiment of the second variation of the invention;

FIG. 16 is a rear view thereof in the assembled condition;

FIG. 17 is a rearview of an alternative application of the first component of the embodiment illustrated in FIGS. 15 and 16;

FIG. 18 is an exploded perspective view of the inside of a corner formed using modified connectors according to the invention, in this instance connecting also a third panel forming a bottom to a container;

FIG. 19 is the same view of the assembled corner; and,

FIG. 20 is an exploded perspective view of an embodiment of the invention in which the two components of a connector are adapted to cooperate to remain in an assembled condition on a first panel in the absence of a fastener or a second panel.

### DETAILED DESCRIPTION WITH REFERENCE TO THE DRAWINGS

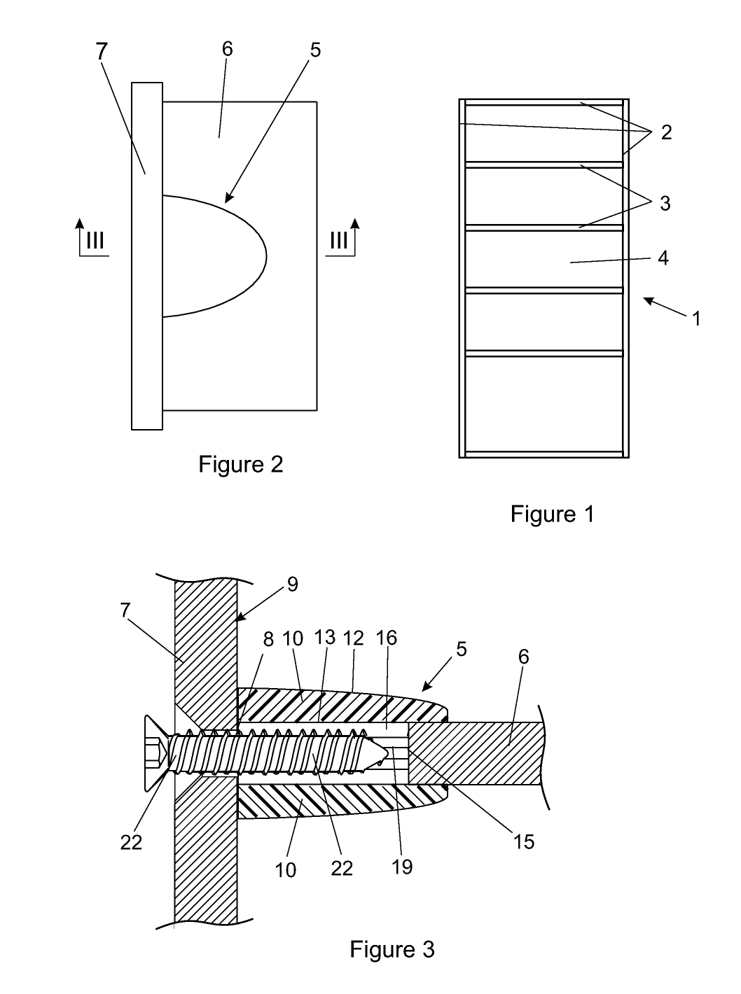

Connectors provided by this invention have extremely broad application in connecting panels together, irrespective of the exact nature or function to be served by the panels. Simply by way of example there is illustrated in FIG. 1, a bookshelf (1) that could be assembled using connectors according to the invention. The panels in this case include surrounding sides, top and bottom (2); shelves (3); and a back panel (4).

Referring now more particularly to FIGS. 2 to 7 of the drawings, a connector (5) according to the invention is provided for connecting a first panel (6) to a second panel (7) with the first panel having one edge (8) thereof fixed relative to a surface (9) of the second panel with the two panels extending transversely to each other, typically at right angles.

The connector, in this embodiment of the invention, comprises two identical components (10) each of which has a generally plate-like base (11) having an operatively outer surface (12), an inner surface (13) and a periphery that is generally arcuate but has a flat abutment edge (14) in a plane at right angles to that of the inner surface (13) and thus the first panel. The flat abutment edge (14) is thus arranged to abut the surface of the second panel in the assembled position. The overall shape of the base is selected such that the base, in each instance, entirely covers an aperture (15) through the first panel near its edge.

The inner surface of each component (10) has a single integral attachment lug (16) projecting therefrom the lug in each instance extending from the flat abutment edge on one side of a centre line (17) that bisects the abutment edge. The lugs are arranged such that with one component inverted relative to the other, the lugs may be arranged to overlap each other in the assembled condition with a small central gap (18) between them.

The inwardly directed surface of each of the lugs has a groove (19), typically of Vee-shape in cross-section, extending along its length in a direction parallel to the centre line. The base of the groove is spaced from the inner surface (13) of the component by a distance somewhat less than one half of a thickness of the first panel (6) to be connected to the second panel (7).

The outer surface (20) of each of the lugs is of part circular shape corresponding to the generally circular shape of the aperture (15) through the first panel. The aperture merges with a narrow opening (21) in order to accommodate a screw threaded fastener (22) in the assembled condition.

The components described above are conveniently made of an injection moulded plastics material that is selected to be particularly suitable for the purpose described herein and that is slightly deformable to allow for the entry of a screw as described below.

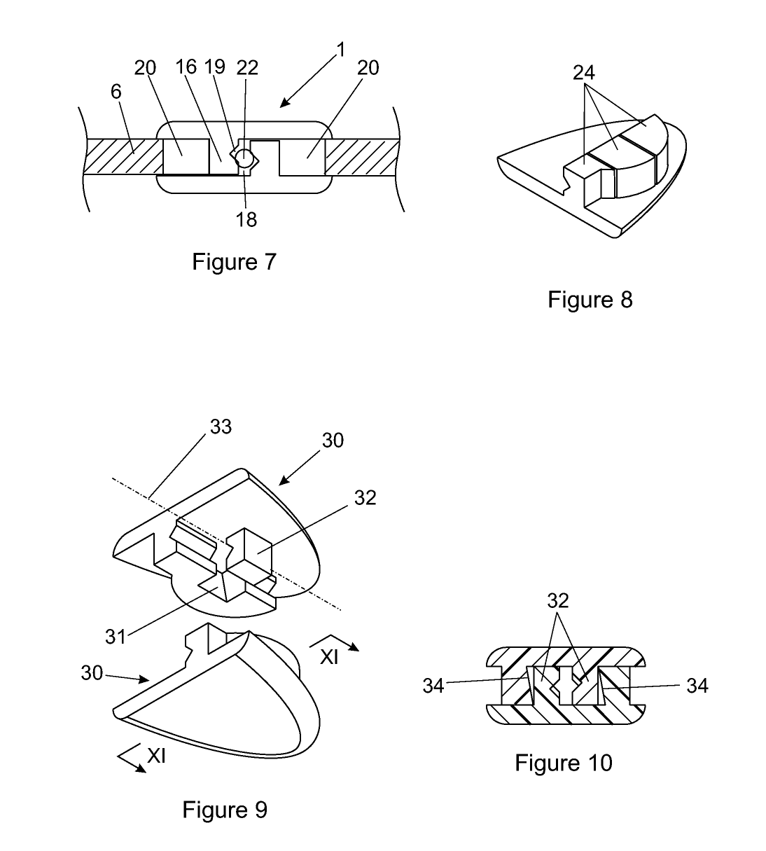

Referring most particularly to FIG. 7, it will be seen that, as a result of the location of the grooves described above, the two grooves will face each other but will be slightly offset from each other in the direction of the thickness of the first panel. The result of this is that entry of the screw threaded fastener tends not only to urge the lugs and therefore the components laterally so that the outer surface (20) of each is urged into engagement with the wall of the aperture, but also the force exerted on the sides of the grooves tends to pull the two components inwards towards each other in the direction of the thickness of the first panel so that the peripheries of the bases firmly engage the surfaces of the first panel.

It will be appreciated that the fastener passes through a hole (23) in the second panel in order to draw the connector towards the surface of the second panel and the flat abutment edge (14) into firm engagement with the surface of the second panel. This effectively locks the components in position relative to the first and second panels.

It is, of course, not essential that each lug is one continuous formation and, as illustrated in FIG. 8, each lug could be divided in the direction of the centreline into a number of segments, in this instance three, as indicated by (24).

FIGS. 9 and 10 of the accompanying drawings illustrate a second embodiment of the first variation of the invention in which two identical components (30) have an arrangement similar to that described above except that each lug has a generally rectangular cut-out (31) intermediate the ends of the groove and a second lug (32) of substantially the same shape and size as the cut-out is provided on the opposite side of the centre line (33). When two reversed components are inter-engaged, the second lug of each is received in the cut-out of the other as shown in FIG. 10.

The wall of each cut out remote from the groove is preferably inclined somewhat outwards towards the base, as indicated by numeral (34) in FIG. 10, so that the second lugs can be flexed outwardly by the screw to provide an additional lock of the two components together in the installed condition. The second lugs also limit the tendency of the two components to move sideways relative to each other.

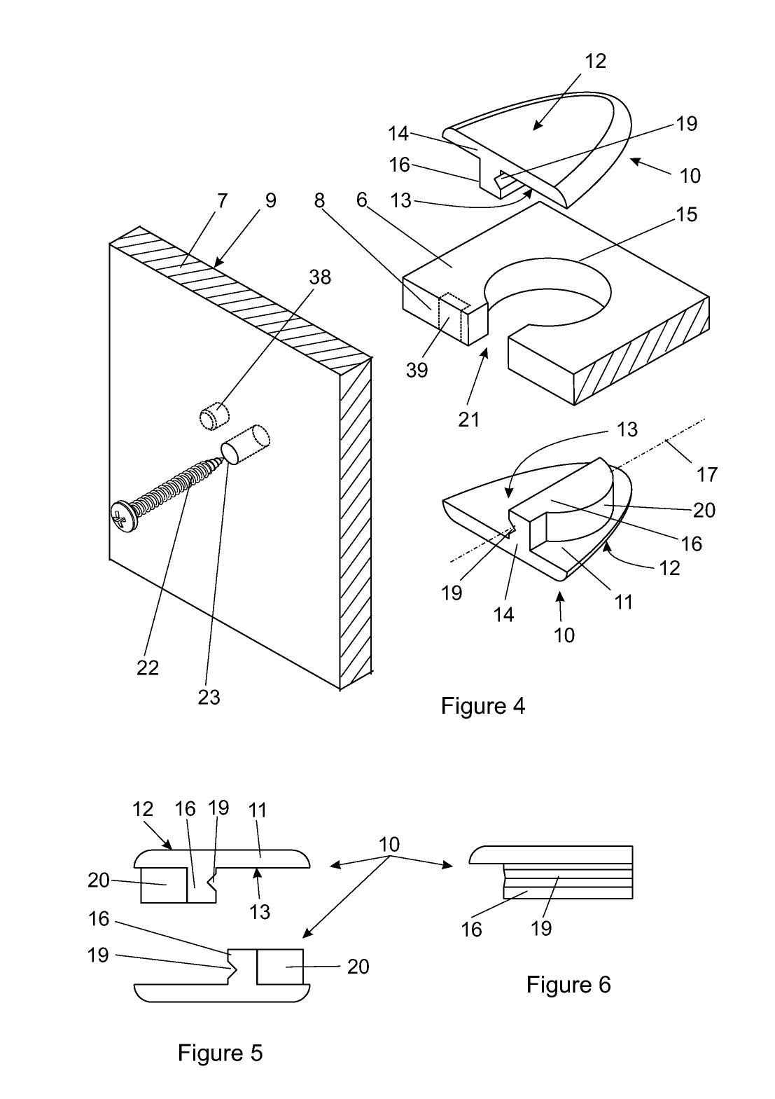

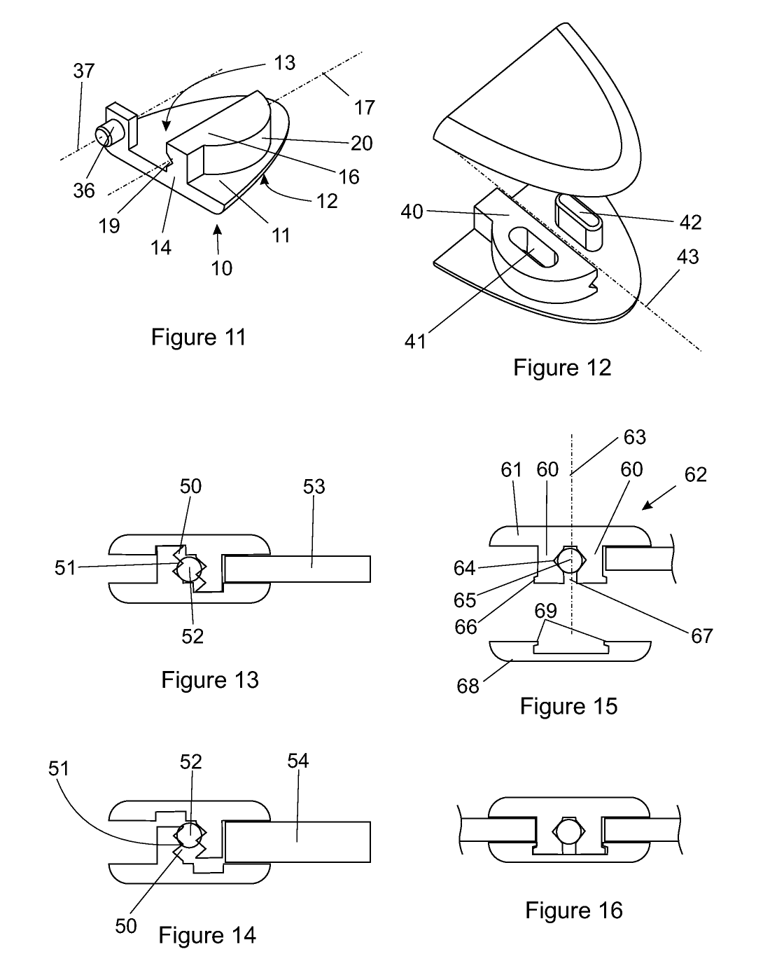

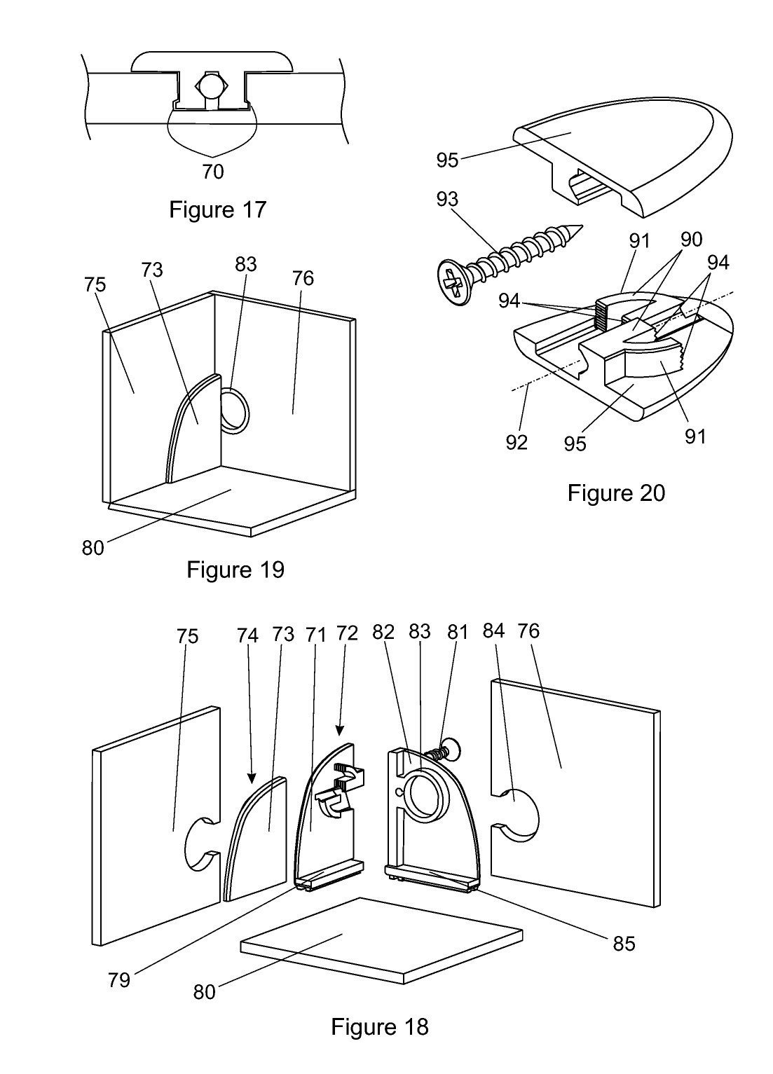

FIG. 11 illustrates another modification of the component illustrated in FIGS. 2 to 7 and as the component is substantially identical, like numerals have been used to indicate like parts of the component. The modification is constituted by a cylindrical protrusion (36) having an axis (37) parallel to, but laterally offset from the centre line (17) of the component (10). Either one or both of the components could be provided with such a cylindrical protrusion that would, operatively, be received in a blind hole (38) that is illustrated in FIG. 4. This cylindrical protrusion, or if each component has such a protrusion the two cylindrical protrusions, will operatively prevent the assembled connector from rotating about the axis of the screw threaded fastener. Of course, as will be quite apparent to those skilled in the art, this expedient may be applied to many, if not all of the other embodiments of the invention described herein.

A third embodiment of the first variation of the invention is illustrated in FIG. 12. In this instance, each of the lugs (40) has a socket (41) formed therein and a corresponding spigot (42) on the opposite side of the centre line (43) and equally spaced therefrom. In this instance, the spigots and sockets of two reversed components inter-engage as the connector is installed and this limits the lateral outward thrust on the side walls of the aperture.

FIGS. 13 and 14 of the drawings illustrate a further embodiment of the first variation of the invention in which each groove (50) is formed as two or more parallel grooves with a central ridge (51) dividing them. The arrangement is such that, as illustrated in FIG. 13, a screw (52) can cooperate with the groove on one side of the central ridge to accommodate one thickness of first panel (53). A second thickness of first panel (54) can be accommodated when the screw engages on the opposite side of the central ridge, as illustrated in FIG. 14.

Turning now to the second variation of the invention, and with reference to FIGS. 15 and 16 of the drawings, two identical lugs (60) are formed integral with a single base (61) of a component (62), one being located on each side of the centreline (63). Each of the lugs is directed inwardly and has a groove (64) for accommodating a screw (65). The two lugs each have on their remote outer edges, an outwardly directed catch formation (66). The two lugs are separated by a slot (67) that enables them to flex inwards or outwards, or both, to enable the lugs to pass through a restricted zone, in this instance in the form of an inwardly lipped opening to a recess in a second component (68) that is formed to cooperate with the lugs and as indicated by (69). The lips therefore form cooperating formations for receiving the catch formations in order to lock the two components together in the operative position. FIG. 15 illustrates the two components in an exploded position relative to each other and FIG. 16 illustrates the operative position thereof in which the screw (65) urges the lugs outwards or at least prevents them from moving inwards so that the catch formations are held engaged beneath the inwardly directed lips of the aperture.

Of course the first component described above can be used without a second component in the event that the aperture through a first panel is suitable for engagement directly by the catch formations to lock the single component in its operative position. Typically, the aperture would be machined to provide a cooperating formation (70) to receive the catch formations on the lugs although it is conceivable that the catch formations could be made sufficiently sharp to penetrate into the surface of the aperture and lock the component in its operative position.

Turning now to the modified connector that is illustrated in FIGS. 18 and 19, an operatively outer base (71) of an operatively outer component (72) of a connector and an operatively inner base (73) of an operatively inner cooperating component (74) of the connector are especially configured for use in connecting a first panel (75) to a second panel (76) at a corner.

In this instance the bases of the components of the connector are extended and each has two straight edges extending at right angles to each other so as to correspond with the edges of the first panel that is to be connected at right angles to the edge of the second panel, both of which are generally upright in this particular instance. The operatively outer component has a flange (79) extending inwards beyond the lower edge of the first panel so as to provide a finish to a corner where the first and second panels meet at generally right angles to each other and, simultaneously, the flange provides a support for a third panel (80) such as may form the bottom of a box, cabinet or the like.

In this particular embodiment of the invention the second panel (76) is not connected directly to the edge of the first panel by means of the screw threaded fastener (81) but, instead, by way of an additional component (82) that has a circular projection (83) cooperating with an aperture (84) formed adjacent the edge of the second panel in exactly the same way as the aperture is formed adjacent the edge of the first panel. This arrangement enables the additional component to also have an inwardly directed flange (85) for cooperation with the third panel. The changes may, of course, in each instance, have integral pegs or spigots (not shown) that engage in cooperant sockets in the edge of the relevant panel.

Similar connectors may be used to connect first and second panels at corners that to define an opening (that is without a third panel), such as an open talk to a box, and in that event, the flanges may optionally be provided with co-operant formations for aligning vertically stacked boxes, cabinets or containers made of panels assembled using these connectors.

Still further, and with reference to FIG. 20, it may be desirable that two connector components can be installed in an aperture in a first panel for transport and storage purposes without the presence of the second panel or the fastener but in readiness for assembly of a first and second panel at a later time. In such an instance, two surfaces of the lugs that are at generally right angles to the plane of the base, and that are in close proximity to each other in the assembled condition of the connector, may be provided with protrusions and recesses or serrations which interact with each other in the assembled condition to hold the two components together temporarily.

In some instances, the aperture in the first panel must be a sufficiently close fit to the outer surfaces of the lugs to maintain the protrusions and recesses or serrations of the two surfaces or the like of the two components in cooperating relationship so as to effectively inhibit the components from separating during transport and storage. In other instances the relevant portions of the lugs may be held in position by other cooperating surfaces of the lugs.

In the instance that is illustrated in FIG. 20, the lugs (90) have a part circular outer surface (91) that is to conform with a generally circular aperture in the first panel. In this instance the lugs are divided into two parts, one of which is located on one side of the axis (92) of the screw (93) and the other of which is located on the opposite side. The surfaces of the faces (94) of the lugs that extend at roughly right angles to the bases (95) in the central region of the component are serrated such that the two sets of serrations of two identical but reversed inter-engaged components interact to maintain the components in association with each other and with an aperture in a first panel without the assistance of the screw. Numerous other arrangements are possible including the simple provision of dimples on one face and correspondingly located protrusions in the form of humps on the other face. In each instance a kind of click stop is provided in the assembled position.

It is to be noted that in an arrangement in which a series of formations are provided, such as a series of serrations, it is possible to make a single connector compatible with a range of different thicknesses of first panel. Thus, for example, a connector having lugs as described with reference to FIG. 20 where in the lugs have a maximum height from the base surface of about 4 mm can be made compatible with first panels having a thickness in the range from about 2.5 mm to about 4 mm. Some of the ranges can be achieved with different shapes and sizes of the components of the connector.

It will be understood that numerous variations may be made to each of the embodiments and variations of the invention described above without departing from the scope hereof.

1. A connector for connecting a first panel to a second panel with the first panel having one edge thereof fixed relative to a surface of the second panel with the two panels extending transversely to each other, the connector comprising:
at least one component having a generally plate-like base with a peripheral edge, an operatively outer surface and an inner surface from which one or more attachment lugs extend that are to be received in an aperture or recess in the first panel at or near said edge thereof, wherein:
the attachment lugs are configured to retain the anchor unit in the assembled condition of the connector by cooperation with a fastener that passes operatively through a hole associated with the second panel,
the peripheral edge of the base is shaped so that the base covers the aperture or recess,
two of the attachment lugs, in the operative position, are laterally offset relative to each other, and
the lugs are shaped for cooperation with the fastener such that the fastener tends to urge the two lugs to lock the component or components in position relative to the first panel as the fastener is introduced into its operative position.

2. A connector as claimed in claim 1 in which the peripheral edge of each base has a flat abutment edge for engaging the surface of the second panel when the fastener is tightened.

3. A connector as claimed in claim 2 in which a cylindrical protrusion is provided at the flat abutment edge with the axis of the cylindrical protrusion being parallel to the operative axis of the fastener but laterally offset therefrom to prevent rotation of the connector about the axis of the fastener in the installed condition.

4. A connector as claimed in claim 1 in which each of the lugs has a groove extending parallel to the axis of the fastener in the installed condition and the grooves are located such that introduction of the fastener between opposed lugs cooperates with the grooves to draw each base of a component towards a first panel surface.

5. A connector as claimed in claim 1 in which the fastener is screw threaded in order to facilitate its progressive introduction between the lugs

6. A connector as claimed in claim 1 in which the components are of injection molded plastic material that is deformable to a limited extent such that a screw thread of a screw threaded fastener can deform the adjacent surface region of a lug to accommodate a part of the thread of a fastener.

7. A connector as claimed in claim 1 in which the connector comprises two generally identical components each of which has one or more lugs positioned such that opposite portions of the lugs of the two components in the operative position are spaced apart so that the fastener may enter a space between the two lugs and by so doing urge the peripheral edge of each of the components towards the adjacent surface of the first panel.

8. A connector as claimed in claim 7 in which each lug has a cutout intermediate its ends and a second lug of substantially the same shape and size as the cutout is provided on the opposite side of a centerline of the component so that in an assembled condition of two components the second lug of one component is accommodated within the cutout of the other.

9. A connector as claimed in claim 8 in which the wall of each cutout remote from the centerline is inclined somewhat outwardly towards the base so that the second legs can be flexed outwards by a fastener to provide an additional lock of the two components together in the installed condition.

10. A connector as claimed in claim 7 in which each of the lugs has a socket formed therein and a corresponding spigot on the opposite side of the centre line and equally spaced therefrom so that the spigots and sockets of two reversed components inter-engage as a connector is operatively assembled.

11. A connector as claimed in claim 1 in which two lugs are formed integral with a single base of a component and the two lugs each have on their remote outer edges outwardly directed catch formations with the two lugs being separated by a slot that enables them to flex inwards or outwards or both to enable the lugs to pass through a restricted zone of an aperture or recess in a first panel with the lugs being operatively urged apart by a fastener introduced between them to cause the catch formations to be urged outwards, in use.

12. A connector as claimed in claim 11 in which a second component is provided comprising a plate-like base having a recess for accommodating the remote ends of the lugs and having cooperating formations for receiving the catch formations in order to lock the two components together in the operative position.

13. A connector as claimed in claim 1 in which two components of a connector have surfaces of the lugs that are at generally right angles to the plane of the base, and that are in close proximity to each other in the assembled condition of the connector, such surfaces being provided with protrusions and recesses or serrations which interact with each other in the assembled condition to hold the two components together temporarily.

14. A connector as claimed in claim 1 in which the base or bases of the components of the connector have extensions that terminate in transverse flanges arranged to project inwards at or beyond an edge of the first or second panel so as to provide a finish to a corner where the first and second panels meet at generally right angles to each other.

15. A connector as claimed in claim 14 in which the transverse flanges are arranged to pass around the edges of a third panel extending at generally right angles to both the first and second panels.
